(19) United States
(12) Patent Application Publication
(10) Pub. No.: US 2007/0070082 A1
(43) Pub. Date: Mar. 29, 2007

(54) Sample-level screen-door transparency using programmable transparency sample masks

(75) Inventor: Christopher Brennan, Holden, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: ATI Technologies, Inc., Markham (CA)

(21) Appl. No.: 11/236,392

(22) Filed: Sep. 27, 2005

(51) Int. Cl. G09G 5/02

(52) U.S. Cl. 345/592

(57) ABSTRACT

Described are a graphics processing unit (GPU) and a sample-level screen-door transparency technique for rendering transparent objects. The GPU includes a scan converter and a shader. The scan converter identifies pixels to be processed for rendering a transparent object and divides each pixel into a plurality of samples. The shader generates, for one of the identified pixels, an application developer-specified transparency sample mask indicating which samples of the pixel are to be suppressed when determining a color of the pixel. Execution of an application developer-specified sample mask command produces a pattern of bits that map to samples of the pixel. The values of the bits determine which samples of the pixel may be used and which samples are to be suppressed when determining a color of the pixel.

### FIELD OF THE INVENTION

The invention relates generally to graphics-processing systems. More specifically, the invention relates to a system and method for performing sample-level screen-door transparency using programmable transparency sample masks.

### BACKGROUND

To achieve three-dimensional scenes of exquisite realism, graphics-processing systems often need to render transparent objects. Various techniques have arisen to approximate the color that results when viewing the background or an object in the background through one or more layers of transparent objects. One common technique is alpha blending. Alpha blending involves a pixel-by-pixel blending of the color of the transparent object with that of the background or of a background object. The color of each pixel includes an alpha value, which represents the opacity of the object. The alpha value determines the extent to which the color of the transparent object is blended with the background. A limitation of this technique, however, is that alpha blending requires a sorting of objects from back-to-front, in order to avoid artifacts that produce incorrect transparencies.

Another technique for rendering transparent objects is called screen-door transparency. In contrast to alpha blending, screen-door transparency does not require back-to-front sorting of objects, and is consequently referred to as being order-independent. The technique of screen-door transparency implements a mesh by rendering only some of the pixels associated with a transparent object. A pixel mask determines which pixels of the transparent object are used and which are suppressed; used pixels possess the color of the object, and suppressed pixels are ignored (the final color for those suppressed pixels derives, potentially, from other objects in front of or behind the transparent object, or from the background). Consequently, the greater the number of suppressed pixels, the more transparent the object appears. A transparent object, however, can fully obscure another transparent object, provided the objects cover the same pixels, and if the same pixel mask is used for both. In addition, interactions between different pixel masks can produce artifacts, such as incorrect opacities and distracting patterns, if the design of the pixel masks is not carefully considered.

Another technique, referred to as alpha-to-coverage, uses the alpha value of a particular pixel to determine the percentage of samples (i.e., sub-pixels) of the pixel that are used to convey the color of the transparent object. To avoid artifacts, most graphics-processing systems employ a simple and predictable algorithm to determine which samples of a pixel to select based on a given alpha value. The results produced by alpha-to-coverage are satisfactory when rendering one transparent object layer on a background, but the technique can produce unrealistic looking results when rendering multiple layers of transparent objects or objects with graduated transparency. There is a need, therefore, for a transparency technique that can satisfactorily render multiple layers of transparent objects and objects with graduated transparency.

### SUMMARY

In one aspect, the invention features a method for rendering a transparent object on a display. The method includes identifying pixels to be processed for rendering the transparent object, dividing each pixel into a plurality of samples, and generating, for one of the pixels, an application developer-specified transparency sample mask indicating which samples of the plurality may contribute to the pixel's color.

In another aspect, the invention features a graphics-processing unit comprising means for storing a flag, a shader, and a depth block. The shader is in communication with the storing means. The shader performs a function that defines a transparency sample mask for a pixel, sets the flag in response to performing the function, and exports attribute data for a pixel. The transparency sample mask indicates which samples of the pixel may contribute to the pixel's color. The depth block is in communication with the shader to receive the exported attribute data and with the storing means to determine a status of the flag. The depth block interprets a portion of the exported attribute data as the transparency sample mask if the flag is set.

In another aspect, the invention features an application program interface for use with a computing system to render a transparent object on a pixel-based display of the computing system. The application program interface comprises an application developer-specified sample mask command that produces, for a pixel, a pattern of bits indicating which samples of the pixel may contribute to the pixel's color.

In another aspect, the invention features a graphics-processing unit for producing graphics images on a display. The graphics-processing unit includes a scan converter identifying pixels to be processed for rendering a transparent object and dividing each pixel into a plurality of samples. In addition, the graphics-processing unit includes a shader generating, for one of the identified pixels, an application developer-specified transparency sample mask indicating which samples of the plurality may contribute to the pixel's color.

In yet another aspect, the invention features a computing system comprising a display including a plurality of pixels and a graphics-processing unit identifying which pixels are to be processed when rendering a transparent object for presentation on the display. The graphics-processing unit divides each identified pixel into a plurality of samples and generates for one of the identified pixels an application developer-specified transparency sample mask indicating which samples of the plurality may contribute to the pixel's color on the display.

In still another aspect, the invention features a method for rendering a transparent object on a display of a computing system. The method comprises providing a function that resolves to a pattern of bits, specifying a sample mask command that invokes the function, and construing the pattern of bits produced by invoking the function as a transparency sample mask that indicates which samples of a pixel may contribute to the pixel's color on the display of the computing system.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an exemplary graphics-processing environment in which aspects of the invention may be implemented.

FIG. 2A shows a diagram of an exemplary transparency sample mask, produced by an execution of an application developer-specified function, the transparency sample mask comprising a pattern of bits that map to samples of the pixel.

FIG. 2B shows a diagram of another exemplary transparency sample mask produced by an execution of another application developer-specified function and demonstrating another example of mapping of bits to samples of the pixel.

FIG. 2C shows a diagram of still another exemplary transparency sample mask produced by an execution of still another application developer-specified function and demonstrating still another example of mapping of bits to samples of the pixel.

FIG. 3 is a flow diagram of an embodiment of a process for performing sample-level screen-door transparency using programmable transparency sample masks, in accordance with the invention.

### DETAILED DESCRIPTION

The degree of realism attained by graphics applications when using screen-door transparency to render overlapping transparent objects or objects of graduated transparency can depend upon the dithering and randomness of the sample masks used to approximate the transparency of the objects. Each transparency sample mask determines which samples of a pixel may contribute to the displayed color of the pixel. The transparency sample mask can identify these samples positively (by identifying each sample that may contribute to the color), negatively (by identifying each sample that does not contribute to the color, i.e., suppressed samples), or by a combination of positive and negative identification of the samples. In general, the number of samples contributing to the pixel's color determines the transparency of the object depicted by those samples: the fewer the number of contributing samples, the more transparent the object appears. The present invention enables developers of graphics application programs to specify one or more functions to generate transparency sample masks that achieve a desired level of dithering, randomness, or both. The ability to specify a mask-generating function gives creative license to graphics application developers when implementing screen-door transparency at the sub-pixel or sample level. In addition, this flexibility extends to the use of currently unknown randomizing and dithering algorithms or functions that may serve to produce a transparency sample mask for achieving a desired transparency effect.

In brief overview, embodiments of the present invention include an application program interface (API) that includes commands for performing sample-level screen-door transparency. One command of the API generates a transparency sample mask for a pixel. An application developer specifies the function that is performed when this command executes. In general, the function produces (or specifies) a bit pattern. The bits of the bit pattern map to the samples of the pixel and their bit values determine which samples of the pixel may contribute to the final pixel color. Depending upon the needs of the graphics application, the application developer can specify the same function or different functions when rendering different pixels (e.g., neighboring pixels) of a transparent object. In addition, the application developer can specify the same or different functions for rendering a pixel covered by overlapping transparent objects.

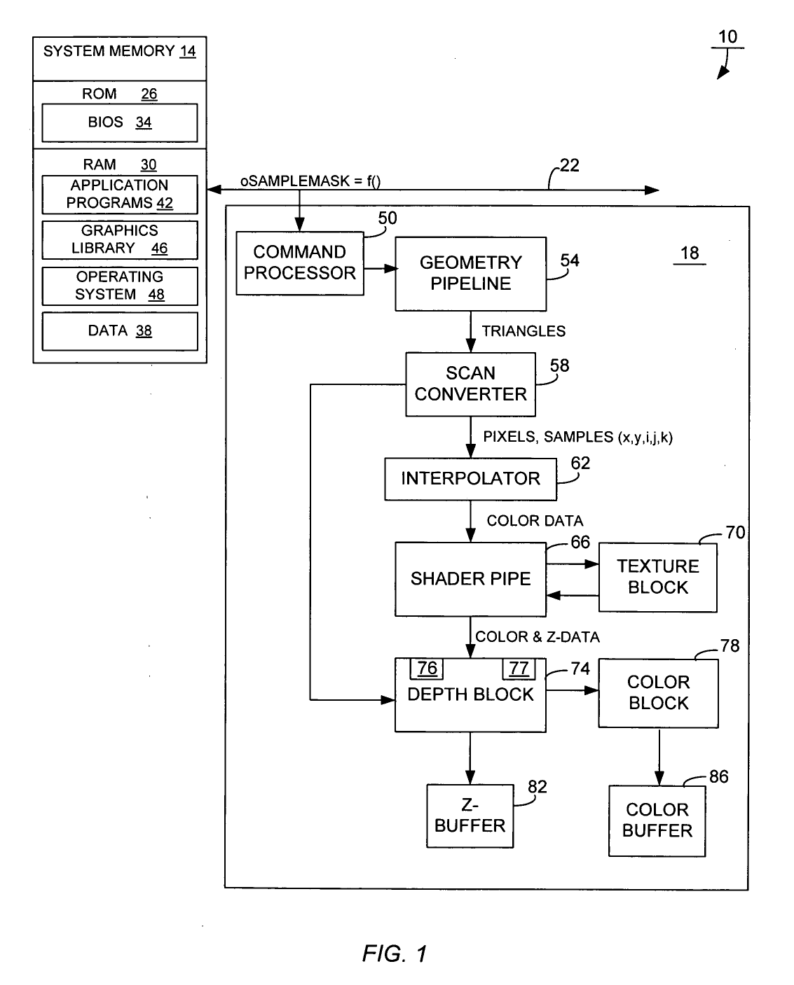

FIG. 1 shows an embodiment of a graphics-processing environment 10 within which the present invention may be implemented. The graphics-processing environment 10 includes a system memory 14 in communication with a graphics-processing unit 18 over a system bus 22. Various examples of graphics-processing environments within which the present invention may be embodied include, but are not limited to, personal computers (PC), Macintosh computers, workstations, laptop computers, server systems, hand-held devices, and game consoles.

The system memory 14 includes non-volatile computer storage media, such as read-only memory (ROM) 26, and volatile computer storage media, such as random-access memory (RAM) 30. Typically stored in the ROM 26 is a basic input/output system (BIOS) 34. The BIOS 34 contains program code for controlling basic operations of the graphics-processing environment 10, including start-up and initialization of its hardware. Stored within the RAM 30 are program code and data 38. Program code includes, but is not limited to, application programs 42, a graphics library 46, and an operating system 48 (e.g., Windows 95™, Windows 98™, Windows NT 4.0, Windows XP™, Windows 2000™, Linux™, SunOS™, and MAC OS™). Examples of application programs 42 include, but are not limited to, standalone and networked video games, simulation programs, word processing programs, and spreadsheet programs.

The graphics library 46 includes an application program interface (API) for use by developers in the generation of graphics application programs. The API provides a set of commands that allow developers to specify geometric objects in two or three dimensions using geometric primitives, such as points, lines, images, bitmaps, and polygons. The commands also control how to render these geometric objects. One such command, referred to hereafter as an “output sample mask” or an oSampleMask command, causes execution of application developer-specified function that generates a transparency sample mask.

The graphics-processing unit 18 includes a command processor 50, a geometry pipeline 54, a scan converter 58, an interpolator 62, a shader pipe (hereafter, shader) 66, a texture block 70, a depth block 74, a color block 78, a z-buffer 82, and a color buffer 86. Although FIG. 1 shows only one representation of each of such components, it is to be understood that the graphics-processing unit 18 can employ parallelism (e.g., a plurality of shaders 66) to accelerate graphics processing. The command processor 50 is coupled to the system bus 22 to receive and process graphics command streams, including oSampleMask commands, issued from a central processing unit (not shown) executing an application program 42. Resulting from such command-stream processing is a stream of register activity (i.e., writes). The command processor 50 forwards primitives and attribute data (e.g., color, position, texture coordinates) to the geometry pipeline 54, which generates triangles from this provided information.

The scan converter 58 is in communication with the geometry pipeline 54 to receive these triangles. For each triangle, the scan converter 58 determines which pixels are fully or partially covered by that triangle and produces a sample mask for each fully or partially covered pixel. Each sample mask produced by the scan converter 58 provides a bit-pattern representation of those samples covered by the triangle. The interpolator 62 is in communication with the scan converter 58 to receive pixel and sample information therefrom, and to determine color value and other attributes for each covered pixel and its samples.

The shader 66 is in communication with the interpolator 62 to receive these color values and attributes for the covered pixels and samples. In general, the shader 66 includes program code for determining a final color and z-value for a pixel, often adding complex shading effects, e.g., texture mapping and transparency, to the appearance of an object. To implement such shading effects, the shader 66 may communicate with the texture block 70 in order to add a texture to the pixels being rendered.

In addition, the shader 66 includes program code for executing instructions that correspond to the various commands of the API of the graphics library 46 used to perform sample-level screen-door transparency, including the oSampleMask command noted above. The following is a general notation for the oSampleMask command:
oSampleMask=X.
In this general notation, X represents any application developer-specified function that is performed upon a call to the oSampleMask command. The application developer-specified function can be program code written specifically by that application developer or taken from existing program code (e.g., within the graphics library). Further, the application developer-specified function can be as simple as equating oSampleMask to a constant value (e.g., oSampleMask=64) or as complex as equating oSampleMask to the result returned by nested function calls.

For example, consider the following function f( ) used to generate a transparency sample mask:
oSampleMask=texture(hash(transparency, x, y, z, seed)).
In this example, the developer specifies the hash function f( ) and the texture call. The hash function can be a developer-defined combination of dithering of the number of covered samples and randomization of the sample order. The transparency and x, y, z coordinates of the pixel are passed to the hash function f( ) as parameters. The seed value permits the application developer to inject pseudo-randomization with reproducibility into the function f( ). The texture call includes an N-bit per texel texture, in which N is at least the number of samples in the pixel. Passing a seed value to the hash function ensures pseudo-randomization of the results returned by the hash function.

The texture call is an example of a technique for applying transparency to the samples in the resulting transparency sample mask. Techniques other than an explicit texture call can be employed (e.g., shader math). In addition, a variety of many other functions, greater or lesser in complexity than that described in this example, can be used to produce a transparency sample mask and to map transparency to the samples of that transparency sample mask.

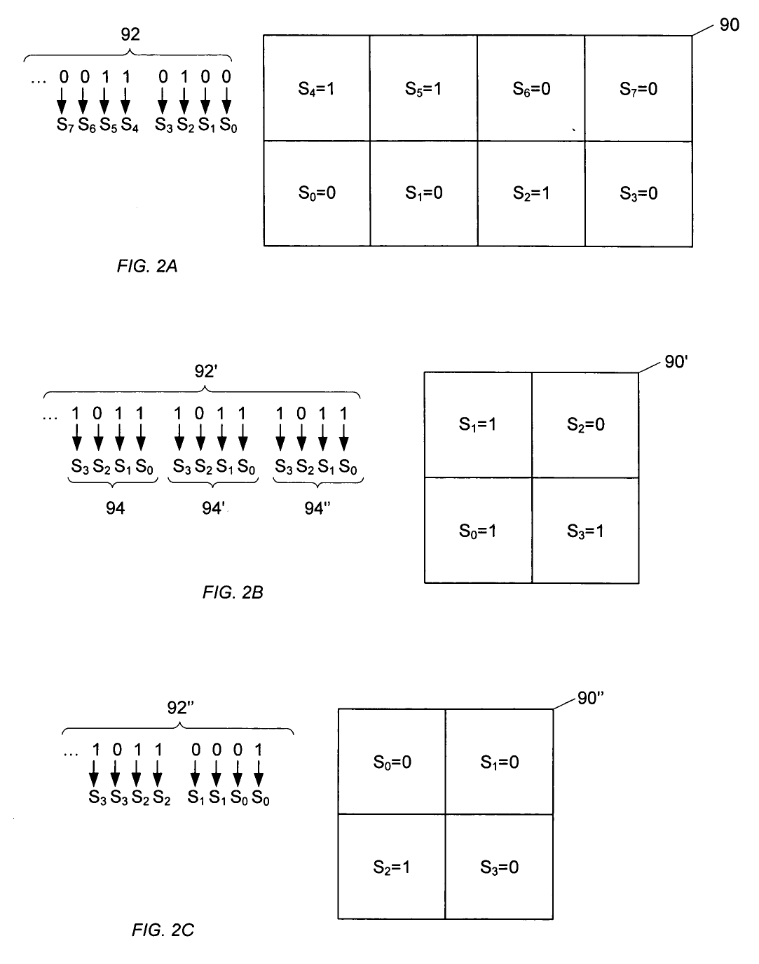

Execution of the function f( ) produces a bit pattern (e.g., 32 bits) that (1) represents the transparency sample mask and (2) indicates a coverage amount. Specific bits of the bit pattern correspond to the specific samples of the pixel. The application developer may or may not know the particular locations of the samples in the pixel to which a given bit of the returned bit pattern corresponds. The coverage amount corresponds to the number (or percentage) of samples in the pixel that may be used to determine the final color of the pixel. Accordingly, the coverage amount corresponds to the degree of transparency of the pixel (or, conversely, its opacity). Having the ability to specify a function or a constant value that represents the transparency sample mask, application developers can choose coverage amounts for pixels that may or may not reflect the alpha values of those pixels. This ability to specify transparency for a pixel independently of its alpha value permits application developers to achieve arbitrary alpha blends. FIGS. 2A-2C provide examples of bit patterns mapped to samples and their coverage amounts.

FIG. 2A shows an exemplary pixel 90 having eight samples (S₀, S₁, S₂ . . . S₇). The particular locations of the eight samples in the pixel are arbitrary. In this example, the developer-specified function f( ) returns a 32-bit value 92. In one embodiment, the eight least significant bits of the 32-bit value correspond to the eight samples of the pixel 90, with each of the eight bits corresponding to one of the samples (as illustrated by the arrows). The other bits of the 32-bit value 92 can be ignored. The value of a given bit determines whether the corresponding sample is used or suppressed. For example, a bit value of “1” indicates that the corresponding sample is used; a bit value of “0”, that the corresponding sample is suppressed. In this example, the coverage amount is 37.5%: three of the eight samples are eligible to represent the fmal color of the pixel 90.

FIG. 2B shows another exemplary mapping of bits to samples. This example serves to illustrate that the transparency sample mask need not be associated with any specific bits of the returned bit value. In this example, each pixel 90′ has four samples (S₀, S₁, S₂, and S₃), and the developer-specified function f( ) returns a 32-bit value 92′. Again, the particular locations of the four samples in the pixel 90′ are arbitrary. In this example, the bit pattern repeats every four bits, and any set of four consecutive bits (e.g., set 94, 94′, or 94″) can be used to represent the transparency sample mask. Each of the four bits in a set of bits corresponds to one of the samples, as illustrated by the arrows. In this example, the coverage amount is 75%: three of the four samples are eligible for use.

FIG. 2C shows still another exemplary mapping of bits to samples. Here, each pixel 90″ has four samples (S₀, S₁, S₂, and S₃), and the function f( ) returns a 32-bit value 92″. The least significant eight bits of the 32-bit value can represent the four samples of the pixel 90″: two bits for each sample, as represented by the arrows. A logical combination of the two bits, e.g., an AND operation, can be used to determine whether the corresponding sample is used or suppressed. In this example, the coverage amount is 25%: one of the four samples is eligible to represent the pixel 90″.

Returning to FIG. 1, during operation, the shader 66 exports attribute data associated with the pixel to the depth block, including color data C._{rgba} and a depth value Z._{rgba}. In addition, the shader 66 exports the sample mask representing the covered geometry (produced by the scan converter and referred to hereafter as a geometry-sample mask) and the transparency sample mask generated by the application developer-specified function. The shader 66 includes the transparency sample mask in the exported attribute data (e.g., in the blue (b) channel of the depth value Z._{rgba}).

The depth block 74 is in communication with the scan converter 58 to receive the x, y, z coordinates of each pixel, and with the shader 66 to receive the exported attribute data. In one embodiment, the depth block 74 also receives a geometry-sample mask for each pixel from the shader 66. In another embodiment, the geometry-sample mask arrives at the depth block 74 from the scan converter 58. In addition, the depth block 74 includes a register 76 for storing a flag. The register 76 is an exemplary embodiment of means for storing the flag; other types of devices for storing the flag include, but are not limited to, volatile and non-volatile memory elements, latches, and flip-flops. When the flag is set, the depth block 74 interprets a portion of the exported attribute data arriving from the shader 66, e.g., the blue channel of the depth value Z._{rgba}, as a transparency sample mask for a given pixel. The use of the blue channel of the depth value Z._{rgba} is an example of conveying the transparency sample mask from the shader 66 to the depth block 74. Other techniques can be used without departing from the principles of the invention.

The depth block 74 also includes circuitry 77 for logically combining (using a Boolean AND operation) this transparency mask with the geometry-sample mask. In addition, the depth block 74 is in communication with the z-buffer 82 and with the color block 78 to merge the depth data and color sample data with the data currently stored for that pixel in the z-buffer 82 and color buffer 86, respectively.

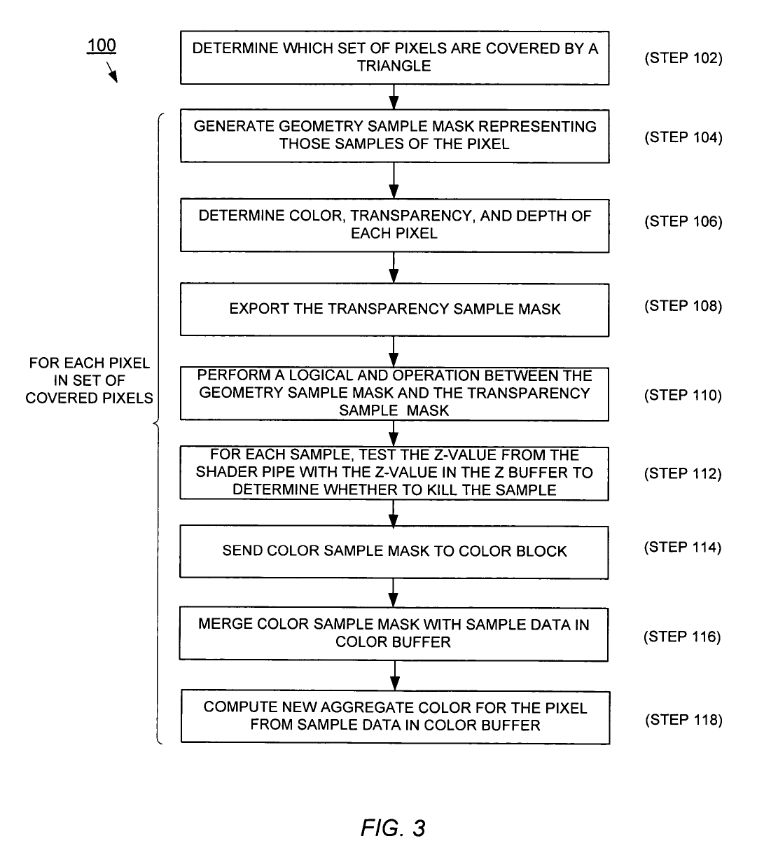

FIG. 3 illustrates an embodiment of a process 100 for rendering transparent objects using sample-level screen-door transparency. In describing the process 100, reference is also made to FIG. 1. The order of steps is exemplary; it is to be understood that one or more of the steps may occur in parallel or in a different order than that shown. For purposes of simplifying the illustration, the description of process 100 starts, at step 102, with the scan converter 58 determining which set of pixels are covered by a triangle (received from the geometry pipeline 54). The remaining described steps of the process 100 occur for each pixel in the set of covered pixels. At step 104, the scan converter 58 generates a geometry sample mask representing those samples of the pixel that the triangle covers. The geometry sample mask passes to the shader 66.

At step 106, the shader 66 determines the color, transparency, and depth of the pixel, and generates an associated transparency sample mask. The generation of the transparency sample mask can involve issuing a texture call to the texture block 70. As described above, the shader 66 generates the transparency sample mask in response to the execution of the oSampleMask command. The shader 66 exports (step 108) the transparency sample mask to the depth block 74 and causes the flag stored in the register 76 of the depth block 74 to be set so that the depth block 74 does not ignore the exported transparency sample mask within the attribute data.

At step 110, the depth block 74 determines that the flag in register 76 is set and performs a logical AND operation between the geometry sample mask and the transparency sample mask. (In general, there are various other masks that the depth block 74 combines also, but such masks are not discussed herein). At step 112, the depth block 74 compares the z-value received from the shader 66 with the z-value currently stored in the z-buffer 82 for each sample of that pixel. Whether a given sample of the pixel passes or fails this depth test is indicated in a color sample mask that the depth block 74 sends (step 114) to the color block 78. The color block 78 merges (step 116) the color sample mask with the color sample data currently stored for that pixel in the color buffer 86—in effect, merging multiple layers of transparent objects, if there are more than one that cover the pixel—and computes (step 118) a new aggregate color for the pixel from the samples.

The present invention may be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPROM, an EPROM, a PROM, a RAM, a ROM, or a magnetic tape. In general, any standard or proprietary, programming or interpretive language can be used to produce the computer-readable software programs. Examples of such languages include C, C++, Pascal, JAVA, BASIC, Visual Basic, and Visual C++. The software programs may be stored on or in one or more articles of manufacture as source code, object code, interpretive code, or executable code.

Although the invention has been shown and described with reference to specific preferred embodiments, it should be understood by those skilled in the art that various changes in form and detail may be made therein without departing from the spirit and scope of the invention as defined by the following claims.

What is claimed is:

1. A method for rendering a transparent object on a display, the method comprising:
identifying pixels to be processed for rendering the transparent object;
dividing each pixel into a plurality of samples; and
generating, for one of the pixels, an application developer-specified transparency sample mask indicating which samples of the plurality may contribute to the pixel's color.

2. The method of claim 1, wherein the step of generating an application developer-specified transparency sample mask includes executing an application developer-specified function that generates the transparency sample mask.

3. The method of claim 2, wherein the step of executing the application developer-specified function includes generating a bit pattern.

4. The method of claim 3, further comprising the step of mapping one bit of the bit pattern to each sample of the pixel.

5. The method of claim 3, further comprising the step of mapping a plurality of bits of the bit pattern to each sample of the pixel.

6. The method of claim 3, wherein the bit pattern identifies a number of samples of the pixel that may be used to determine a color of the pixel.

7. The method of claim 2, wherein the step of executing the application developer-specified function includes executing a hashing function.

8. The method of claim 7, wherein the step of executing the hashing function includes dithering a number of the samples that may be used to determine a color of the pixel.

9. The method of claim 7, wherein the step of executing the hashing function includes randomizing an order of the samples.

10. The method of claim 2, wherein the step of executing the application developer-specified function includes issuing a texture call to apply a texture to each sample of the pixel.

11. The method of claim 2, wherein the application developer-specified function is a first application developer-specified function, and further comprising generating a transparency sample mask for a second one of the pixels by executing a second application developer-specified function different from the first application developer-specified function.

12. The method of claim 2, further comprising the step of exporting attribute data for the pixel in response to the execution of the application developer-specified function, wherein the transparency sample mask is embodied in a portion of the attribute data.

13. The method of claim 12, wherein the attribute data include a Z-value for the pixel, the Z-value having red, blue, green, and alpha channels, one of such channels conveying the transparency sample mask.

14. The method of claim 12, further comprising the steps of setting a flag in response to executing the application developer-specified function, and of interpreting the portion of the exported attribute data as the transparency sample mask if the flag is set.

15. A graphics-processing unit, comprising:
means for storing a flag;
a shader in communication with the storing means, the shader performing a function that defines a transparency sample mask for a pixel, setting the flag in response to performing the function, and exporting attribute data for a pixel, the transparency sample mask indicating which samples of the pixel may contribute to the pixel's color; and
a depth block in communication with the shader to receive the exported attribute data and with the storing means to determine a status of the flag, the depth block interpreting a portion of the exported attribute data as the transparency sample mask if the flag is set.

16. An application program interface for use with a computing system to render a transparent object on a pixel-based display of the computing system, the application program interface comprising:
an application developer-specified sample mask command that produces, for a pixel, a pattern of bits indicating which samples of the pixel may contribute to the pixel's color.

17. The application program interface of claim 16, wherein the pattern of bits maps to a transparency sample mask for the pixel.

18. The application program interface of claim 16, wherein the application developer-specified sample mask command includes a hashing function.

19. The application program interface of claim 18, wherein the hashing function dithers a number of the samples that may be used to determine a color of the pixel and randomizes an order of the samples.

20. The application program interface of claim 18, wherein the hashing function randomizes an order of the samples.

21. The application program interface of claim 16, wherein the application developer-specified sample mask command includes a texture call to apply a texture to each sample of the pixel.

22. A graphics-processing unit for producing graphics images on a display, comprising:
a scan converter identifying pixels to be processed for rendering a transparent object and dividing each pixel into a plurality of samples; and
a shader generating, for one of the identified pixels, an application developer-specified transparency sample mask indicating which samples of the plurality may contribute to the pixel's color.

23. The graphics-processing unit of claim 22, wherein the shader generates the transparency sample mask by executing one or more instructions that correspond to an application developer-specified sample mask command.

24. The graphics-processing unit of claim 23, wherein the shader generates a pattern of bits that map to the samples of the pixel by executing the one or more instructions of the application developer-specified sample mask command.

25. The graphics-processing unit of claim 24, further comprising a depth block mapping the bits of the bit pattern to the samples of the pixel.

26. The graphics-processing unit of claim 22, further comprising a texture block in communication with the shader, and wherein the shader issues a texture call to the texture block to apply a texture to each sample of the pixel.

27. The graphics-processing unit of claim 22, further comprising a depth block in communication with the shader to receive the transparency sample mask therefrom.

28. A computing system, comprising:
a display including a plurality of pixels;
a graphics-processing unit identifying which pixels are to be processed when rendering a transparent object for presentation on the display, the graphics-processing unit dividing each identified pixel into a plurality of samples and generating for one of the identified pixels an application developer-specified transparency sample mask indicating which samples of the plurality may contribute to the pixel's color on the display.

29. A method for rendering a transparent object on a display of a computing system, the method comprising:
providing a function that resolves to a pattern of bits;
specifying a sample mask command that invokes the function;
construing the pattern of bits produced by invoking the function as a transparency sample mask that indicates which samples of a pixel may contribute to the pixel's color on the display of the computing system.
